(19) United States
(12) Patent Application Publication
(10) Pub. No.: US 2020/0052556 A1
(43) Pub. Date: Feb. 13, 2020

(54) ELECTRIC-MOTOR HEAT DISSIPATION MEMBER, ELECTRIC MOTOR AND AIRCRAFT

(71) Applicant: AUTEL ROBOTICS CO., LTD., Shenzhen (CN)

(72) Inventors: Dongdong LUO, Shenzhen (CN); Wei SUN, Shenzhen (CN); Wenbing SU, Shenzhen (CN)

(21) Appl. No.: 16/656,784

(22) Filed: Oct. 18, 2019

Related U.S. Application Data
(63) Continuation of application No. PCT/CN2017/114779, filed on Dec. 6, 2017.

(30) Foreign Application Priority Data
Apr. 19, 2017 (CN) 201710258786.0

(51) Int. Cl. H02K 9/22; H02K 21/22; B64C 39/02; B64D 27/24; B64D 33/08

(52) U.S. Cl. CPC H02K 9/22; H02K 21/22; B64C 39/024; B64C 2201/108; B64D 33/08; B64C 2201/042; B64C 2201/027; B64D 27/24

(57) ABSTRACT

Embodiments of the present application discloses an electric-motor heat dissipation member, an electric motor and an aircraft. The electric-motor heat dissipation member includes a main body and heat dissipation fins disposed on the main body. The main body has an upper end surface, a lower end surface, an outer wall surface located between the upper end surface and the lower end surface, and an inner wall surface opposite to the outer wall surface. The heat dissipation fins are disposed on the inner wall surface. The heat dissipation fin has a first end portion close to the upper end surface and a second end portion close to the lower end surface. According to the embodiments of the present application, by applying the electric-motor heat dissipation member to an electric motor and applying the electric motor to an aircraft, heat inside the electric motor can be actively taken away, so that the heat dissipation efficiency of the electric motor is improved, thereby ensuring the flying efficiency and the safety performance of the aircraft.

### BACKGROUND

### Technical Field

The present application relates to the technical field of electric motors, and more particularly to an electric-motor heat dissipation member, an electric motor using the electric-motor heat dissipation member and an aircraft using the electric motor.

### Related Art

Currently, with the advantages of low loss, low noise, smooth running and long service life, brushless electric motors have been widely applied to various mechatronics fields, especially the field of aircraft technologies. However, the electric motor generates a large amount of heat during use, and if the heat cannot be dissipated in time, the normal use of the electric motor will be affected, and the performance requirements of the aircraft cannot be met.

Particularly, when the aircraft needs to fly in various poses, such as fast climb, wind-resistant flight or violent flight, at the maximum acceleration, the electric motor is required to drive the propeller to rotate at a high speed. However, the electric motor generates a large amount of heat during heavy load operation. If the heat dissipation effect of the electric motor is poor, the temperature of the electric motor will be too high when the aircraft works at the maximum acceleration, and demagnetization of the magnet will occur due to high temperature, reducing the performance and efficiency of the electric motor, affecting the flight of the aircraft. In addition, as the arms of the aircraft are mostly made of plastics, the unduly high temperature of the electric motor causes the part of the arms mounted at the electric motor to melt, affecting the safety performance of the aircraft.

### SUMMARY

Embodiments of the present application provide an electric-motor heat dissipation member, an electric motor and an aircraft, to the problem in the prior art that local unduly high temperature of the arm of the aircraft resulting from the low heat dissipation efficiency of the electric-motor heat dissipation member causes plastics to melt and affects the flight performance.

To resolve the above technical problem, one technical solution adopted by the present application is to: provide an electric-motor heat dissipation member, including a main body and heat dissipation fins disposed on the main body, the main body having an upper end surface, a lower end surface, an outer wall surface located between the upper end surface and the lower end surface, and an inner wall surface opposite to the outer wall surface, wherein the heat dissipation fins are disposed on the inner wall surface, and the heat dissipation fin has a first end portion close to the upper end surface and a second end portion close to the lower end surface.

Optionally, an angle between the heat dissipation fin and a plane formed by the upper end surface is an acute angle.

Optionally, an angle θ between a line connecting the first end portion and the second end portion and a plane perpendicular to an axis of the main body is an acute angle.

Optionally, the angle θ satisfies: 2°≤θ≤30°.

Optionally, a plurality of clamping blocks is disposed at intervals along a circumferential direction of the outer wall surface of the main body.

Optionally, a plurality of bosses protruding in a direction away from the upper end surface is disposed along a circumferential direction of the lower end surface, a clamping portion being formed between any two neighboring bosses.

Optionally, the heat dissipation fin is arc-shaped, airfoil-shaped or S-shaped.

Optionally, using a line connecting the first end portion and the second end portion along an outer surface of the heat dissipation fin 3132 as a chord, a central angle corresponding to the chord is 12°-30°.

To resolve the above technical problem, another technical solution adopted by the present application is to: provide an electric motor, including a stator and a rotor sleeved on a periphery of the stator and rotatable about the stator, the electric motor further including an electric-motor heat dissipation member connected to the rotor, the electric-motor heat dissipation member including a main body and heat dissipation fins disposed on the main body, the main body having an upper end surface, a lower end surface, an outer wall surface located between the upper end surface and the lower end surface, and an inner wall surface opposite to the outer wall surface, wherein the heat dissipation fins are disposed on the inner wall surface, and the heat dissipation fin has a first end portion close to the upper end surface and a second end portion close to the lower end surface.

Optionally, an angle between the heat dissipation fin and a plane formed by the upper end surface is an acute angle.

Optionally, an angle θ between a line connecting the first end portion and the second end portion and a plane perpendicular to an axis of the main body is an acute angle.

Optionally, the angle θ satisfies: 2°≤θ≤30°.

Optionally, a plurality of clamping blocks is disposed at intervals along a circumferential direction of the outer wall surface of the main body; and the rotor includes a housing sleeved on the periphery of the stator and rotatable about the stator, an outer cover connected to an end of the housing and a permanent magnet disposed on a surface of the housing facing the stator, the outer cover being provided with grooves at positions corresponding to the clamping blocks, the clamping blocks being engaged in the grooves.

Optionally, a plurality of bosses protruding in a direction away from the upper end surface is disposed along a circumferential direction of the lower end surface, a clamping portion being formed between any two neighboring bosses; and an end surface of the permanent magnet facing the outer cover being received in the clamping portion.

Optionally, a distance between the second end portion of the heat dissipation fin and an end surface of the stator facing the outer cover is not less than 0.5 mm.

Optionally, the heat dissipation fin is arc-shaped, airfoil-shaped or S-shaped.

Optionally, using a line connecting the first end portion and the second end portion along an outer surface of the heat dissipation fin 3132 as a chord, a central angle corresponding to the chord is 12°-30°.

To resolve the above technical problem, another technical solution adopted by the present application is to: provide an electric-motor, including a rotor and a stator sleeved on a periphery of the rotor, the rotor being rotatable relative to the stator, the electric motor further including an electric-motor heat dissipation member connected to the rotor, the electric-motor heat dissipation member including a main body and heat dissipation fins disposed on the main body, the main body having an upper end surface, a lower end surface, an outer wall surface located between the upper end surface and the lower end surface, and an inner wall surface opposite to the outer wall surface, wherein the heat dissipation fins are disposed on the inner wall surface, and the heat dissipation fin has a first end portion close to the upper end surface and a second end portion close to the lower end surface.

Optionally, an angle between the heat dissipation fin and a plane formed by the upper end surface is an acute angle.

Optionally, an angle θ between a line connecting the first end portion and the second end portion and a plane perpendicular to an axis of the main body is an acute angle.

Optionally, the angle θ satisfies: 2°≤θ≤30°.

Optionally, a plurality of clamping blocks is disposed at intervals along a circumferential direction of the outer wall surface of the main body; and the stator includes a housing sleeved on the periphery of the rotor, an outer cover connected to an end of the housing, the rotor includes a permanent magnet disposed facing an inner surface of the stator, the rotor is provided with grooves at positions corresponding to the clamping blocks, the clamping blocks being engaged in the grooves.

Optionally, a plurality of bosses protruding in a direction away from the upper end surface is disposed along a circumferential direction of the lower end surface, a clamping portion being formed between any two neighboring bosses, and an end of the permanent magnet being received in the clamping portion.

Optionally, a distance between the heat dissipation fin and the stator is not less than 0.5 mm.

Optionally, the heat dissipation fin is arc-shaped, airfoil-shaped or S-shaped.

Optionally, using a line connecting the first end portion and the second end portion along an outer surface of the heat dissipation fin as a chord, a central angle corresponding to the chord is 12°-30°.

To resolve the above technical problem, still another technical solution adopted by the present application is to: provide an aircraft, including an aircraft body, an arm extending from the aircraft body and a power plant disposed on the arm, the power plant including the above-mentioned electric motor connected to the arm and a propeller connected to the electric motor, the electric motor being configured to provide power for rotation of the propeller.

Optionally, the power plant is mounted toward above the aircraft body, and the heat dissipation fin of the electric motor is arc-shaped or airfoil-shaped and has a convex arc surface curved toward the upper end surface of the main body of the electric-motor heat dissipation member and a concave arc surface curved toward the lower end surface of the main body of the electric-motor heat dissipation member.

Optionally, the power plant is mounted toward below the aircraft body, and the heat dissipation fin of the electric motor is arc-shaped or airfoil-shaped and has a concave arc surface curved toward the upper end surface of the main body of the electric-motor heat dissipation member and a convex arc surface curved toward the lower end surface of the main body of the electric-motor heat dissipation member.

The embodiments of the present application have the following beneficial effects: The electric-motor heat dissipation member provided in the embodiments of the present application can form a turbulent air flow inside the electric motor when the rotor drives the electric-motor heat dissipation member to rotate, and the turbulent air flow can actively take away heat generated inside the electric motor, thereby improving the heat dissipation efficiency of the electric motor. Further, the application of the electric motor using the electric-motor heat dissipation member to an aircraft can improve the flying efficiency and the safety performance of the aircraft and prevent the problem of local melting of plastics of the arm caused by low heat dissipation efficiency of the electric motor.

### BRIEF DESCRIPTION OF THE DRAWINGS

To describe the technical solutions in the embodiments of this application more clearly, the accompanying drawings required in the embodiments of this application are briefly described below. Apparently, the accompanying drawings in the following description merely show some embodiments of this application, and persons of ordinary skill in the art may still derive other drawings from these accompanying drawings without creative effort.

FIG. 1 is a three-dimensional schematic structural diagram of an aircraft according to an embodiment of the present application;

FIG. 2 is a three-dimensional structural diagram of an electric motor in the aircraft shown in FIG. 1;

FIG. 3 is a three-dimensional structural diagram of the electric motor shown in FIG. 2 from another viewing angle;

FIG. 4 is an exploded diagram of the electric motor shown in FIG. 2 from top to bottom;

FIG. 5 is an exploded diagram of the electric motor shown in FIG. 2 from bottom to top;

FIG. 6 is a cross-sectional view of the electric motor shown in FIG. 2;

FIG. 7 is a schematic structural diagram of an outer cover in the electric motor shown in FIG. 6;

FIG. 8 is a schematic structural diagram of an electric-motor heat dissipation member in the electric motor shown in FIG. 6;

FIG. 9 is an enlarged view of part A in FIG. 8;

FIG. 10 is a schematic structural diagram of another electric-motor heat dissipation member according to an embodiment of the present application; and

FIG. 11 is a schematic structural diagram of still another electric-motor heat dissipation member according to an embodiment of the present application.

### DETAILED DESCRIPTION

For ease of understanding the present invention, the present invention is described in further detail below with reference to the accompanying drawings and specific embodiments. It should be noted that an element described as being “fixed” to another element may be directly on the other element, or one or more intervening components may be present. An element described as being “connected” to another element may be directly connected to the other element, or one or more intervening components may be present. The terms “vertical”, “horizontal”, “left”, “right” and similar expressions used in this specification are merely for the purpose of illustration.

Unless otherwise defined, all technical and scientific terms used in this specification have the same meaning as commonly understood by persons of ordinary skill in the art to which this application belongs. The terms used in the specification of this application are merely used for describing specific embodiments, and are not intended to limit this application. In addition, the technical features provided in the implementations of this application to be described below may be combined with each other as long as no conflict occurs. The term “and/or” used in this specification includes any and all combinations of one or more related items listed.

An electric motor provided in the embodiments of the present application is an active heat-dissipating type electric motor which can actively dissipate heat during running, and is applicable to any application field of mechatronics, especially the field of aircrafts such as drones. In the embodiments of the present application, the application of the active heat-dissipating type electric motor to an aircraft can improve the flying efficiency and the safety performance of the aircraft.

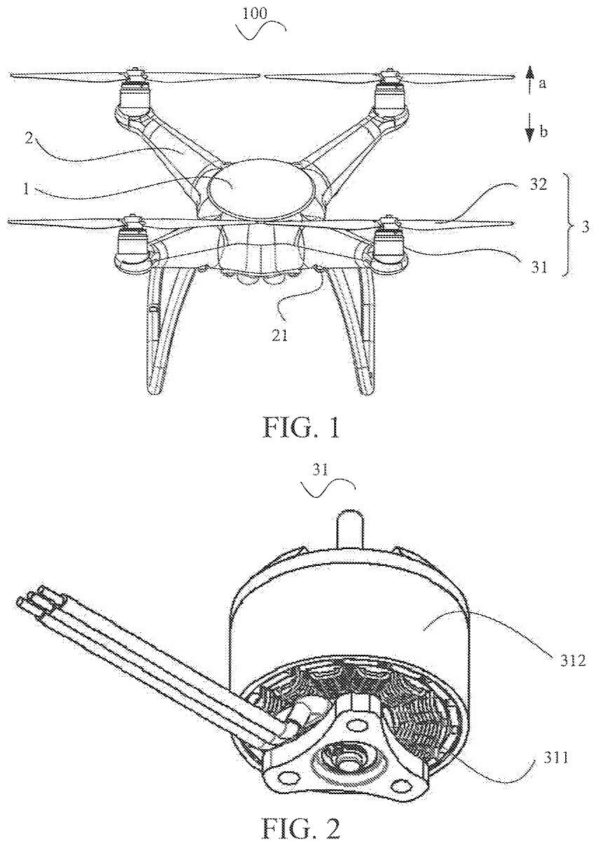

FIG. 1 is a schematic structural diagram of an aircraft according to an embodiment of the present application. Referring to FIG. 1, the aircraft 100 includes: an aircraft body 1, four arms 2 extending from the aircraft body 1 and power plants 3 respectively disposed on the arms 2. In some embodiments, an indicator light 21 is further disposed on the arm 2. The indicator light 21 is disposed at a position distant from the power plant 3, to prevent heat generated by the indicator light 21 during operation from being transferred to the electric motor 31 in the power plant 3 to cause an unduly high temperature of the electric motor 31 to increase the heat dissipation burden of the electric motor 31. The aircraft 100 may further include a gimbal (not shown), the gimbal being mounted at the bottom of the aircraft body 1. The gimbal may be equipped with a high-definition digital camera or other devices to satisfy the user's particular requirements.

The power plant 3 may be mounted toward above the aircraft body 1 (direction a shown in FIG. 1), or mounted toward below the aircraft body 1 (direction b shown in FIG. 1). Alternatively, one arm 2 is provided with two power plants 3, one of the power plants 3 being toward above the aircraft body 1, the other power plant being toward below the aircraft body 1, and the two power plants 3 being disposed coaxially. The direction toward which the power plant 3 is mounted is not specifically limited in the embodiments of the present application.

Specifically, the power plant 3 includes an electric motor 31 connected to the arm 2 and a propeller 32 connected to the electric motor 31. The electric motor 31 is configured to provide power for rotation of the propeller 32. When operating, the electric motor 31 drives the propeller 32 to rotate along a particular direction (that is, the rotation direction of the electric motor 31: clockwise or anticlockwise) to provide a lifting force for the aircraft 100, to drive the aircraft 100 to fly.

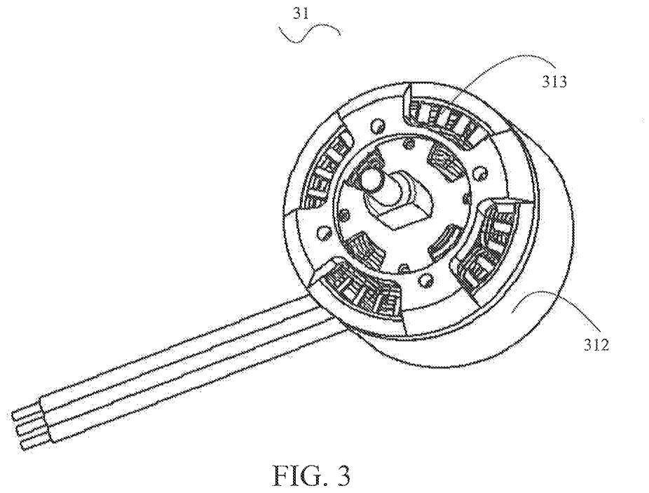

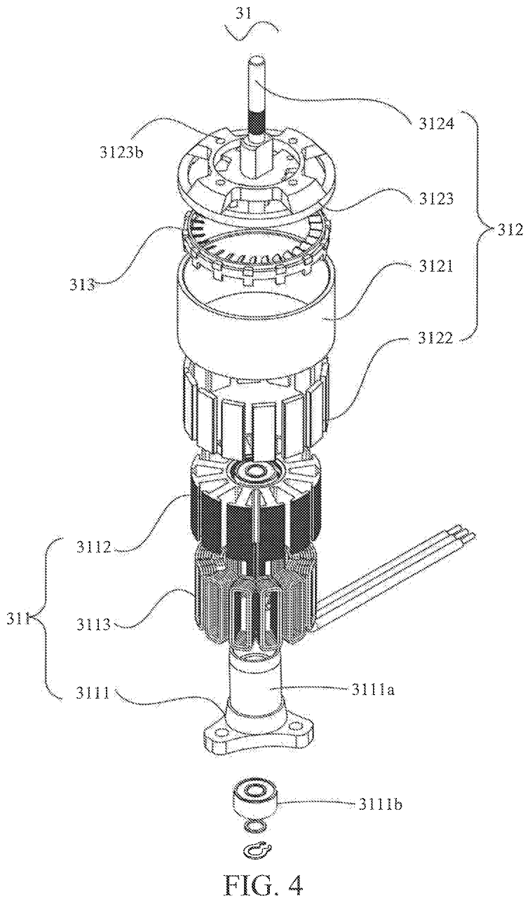

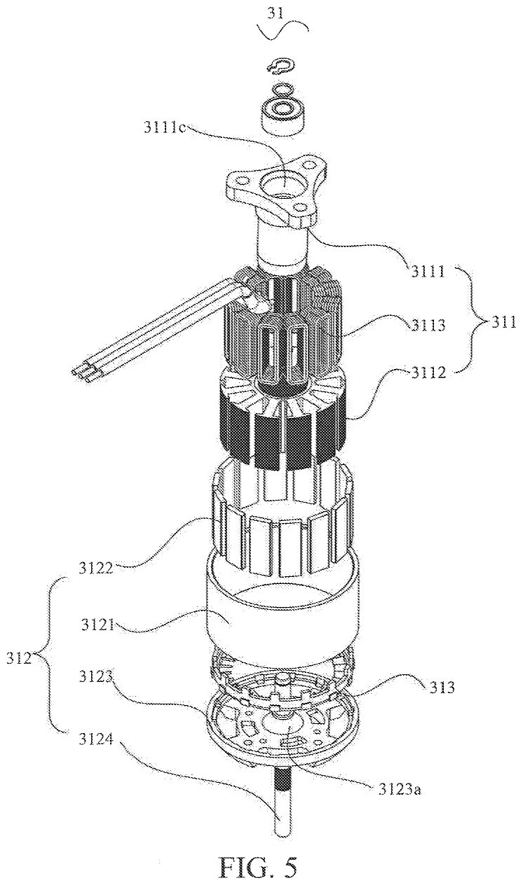

In the embodiments of the present application, the electric motor 31 is an active heat-dissipating type electric motor which can actively take heat generated therein away to outside air during running, having a three-dimensional structure as shown in FIG. 2 and FIG. 3. Referring to FIG. 4 and FIG. 5, the electric motor 31 includes: a stator 311, a rotor 312 and an electric-motor heat dissipation member 313. The rotor 312 is sleeved on a periphery of the stator 311 and rotatable about the stator 311. The electric-motor heat dissipation member 313 is connected to the rotor 312. When the electric motor 31 operates, the rotor 312 drives the electric-motor heat dissipation member 313 to rotate. The rotation of the rotor 312 causes air around to flow. The electric-motor heat dissipation member 313 generates an upward or downward induction force for the air to form a turbulent air flow inside the electric motor 31, so that the turbulent air flow actively takes away the heat generated inside the electric motor 31.

Specifically, the stator 311 includes: a stator base 3111, an iron core 3112 and a coil 3113, the iron core 3112 being sleeved on the stator base 3111, and the coil 3113 being wound on the iron core 3112.

The stator base 3111 is configured to fasten the electric motor 31 to the arm 2. In an implementation, to enhance the heat dissipation effect of the electric motor 31, the stator base 3111 is designed as an open structure. For example, when an air flow inside the electric motor 31 can flow out of the electric motor 31 through the stator base 3111, it is considered that the stator base is an open structure. The stator base 3111 is provided therein with a bearing cavity 3111a, a bearing 3111b being nested in the bearing cavity 3111a. In some embodiments, a vent hole 3111c allowing air to flow through is further provided on the stator base 3111 along an axial extension direction of the bearing 3111b, to allow the flowing air to take away the heat generated inside the electric motor 31, thereby enhancing the heat dissipation effect. The stator base 3111 may be formed from an aluminum alloy or steel, and may be of an integral (for example, T-shaped) or split type. In this embodiment, the stator base 3111 is an integral structure formed of an aluminum alloy material to enhance its stability and thermal conductivity.

The iron core 3112 includes a body and an insulation layer covering the surface of the body. The body may be formed by stacking an easily magnetizable material (for example, steel, nickel, or iron). Preferably, to reduce the weight of the electric motor, the body may be formed by stacking steel plates. The thickness or average thickness of the steel plate may be set to 0.2 mm to 0.5 mm. The insulation layer is configured to insulate the body from the coil 3113, to prevent a short circuit of the electric motor. The insulation layer may be formed by any material having insulating properties, for example, plastic or digital powder. Preferably, in this embodiment, to reduce as much as possible the amount of heat generated by the electric motor while ensuring the insulating effect, the insulation layer is formed by digital powder applied on the surface of the body, and has a thickness or average thickness of 0.1 mm to 0.25 mm.

The coil 3113 wound on the iron core 3112 at least has one layer. To improve the efficiency of the electric motor 31 and reduce the amount of heat generated by the electric motor 31, the coil 3113 may be formed by winding a single or a plurality of enameled copper wires. The number of turns of the coil 3113 may be set to 15, 16, 17, or the like. Preferably, to reduce the amount of heat generated while ensuring the torque of the electric motor 31, the number of turns of the coil 3113 may be set to 16.

The rotor 312 includes: a housing 3121, a plurality of permanent magnets 3122, an outer cover 3123 and a rotary shaft 3124. The housing 3121 is rotatably sleeved on a periphery of the iron core 3112 and is rotatable about the iron core 3112. The plurality of permanent magnets 3122 is disposed on a surface of the housing 3121 facing the iron core 3112 and is spaced apart from the iron core 3112 by a gap. The outer cover 3123 is connected to an end of the housing 3121 distant from the stator base 3111. A shaft hole 3123a is provided at the center of the outer cover 3123. One end of the rotary shaft 3124 is passed through the shaft hole 3123a and mounted in the bearing 3111b of the stator base. The rotary shaft 3124 is securely connected to the outer cover 3123. The other end of the rotary shaft 3124 is configured to connect to the propeller 32 in an anti-rotation manner, to drive the propeller 32 to rotate.

The housing 3121 is of a cylindrical structure, and may be made of a highly magnetically permeable material such as 10# steel or 20# steel. In practical applications, when the electric motor 31 is mounted on the arm 2 of the aircraft 100, a distance between the bottom of the housing 3121 and the arm 2 is 0.4 mm to 1 mm, to prevent interference with the electric motor and prevent the electric motor from being jammed to cause failure of the electric motor and affect the safety of the aircraft.

The permanent magnet 3122 may be of any shape such as arc or rectangle. Depending on the requirements of the electric motor, the number of permanent magnets may be set to any value, for example, 10, 14, 16, or 18, and the height or average height of the permanent magnet may be 8 mm, 9 mm, 10 mm, 11 mm, 12 mm, or 13 mm. The material of the permanent magnet 3122 may be a magnetic material such as ferrite or neodymium iron boron, and the thickness or average thickness of the permanent magnet may be 0.8 mm, 0.9 mm, 1 mm, 1.1 mm, 1.2 mm, or 1.3 mm. Preferably, to improve the heat dissipation efficiency of the electric motor while meeting the performance requirements of the electric motor, the material of the permanent magnet 3122 is neodymium iron boron, and the thickness or average thickness of the permanent magnet is set to 1.1 mm.

As shown in FIG. 7, the outer cover 3123 is an open structure. Similar to the open structure of the stator base 3111, a plurality of heat dissipation holes 3123b allowing air to pass through may be provided on the outer cover 3123. The heat dissipation holes 3123b are arranged along a circumferential direction of the outer cover 3123, to further improve the heat dissipation efficiency of the electric motor. In addition, in some implementations of the embodiments of the present application, one side of the outer cover 3123 connected to the housing 3121 may further be provided with a plurality of grooves 3123c along the circumferential direction, the grooves 3123c being configured to fasten the heat dissipation member.

In some embodiments, to increase the firmness of the connection between the rotary shaft 3124 and the outer cover 3123 to increase the mechanical strength of the electric motor, a rough surface or a flat portion may be provided at the firm connection part between the rotary shaft 3124 and the outer cover 3123 (that is, at the shaft hole). The rough surface may be knurled, having a length less than or equal to the length of the shaft hole 3123a, to prevent the rough surface or flat portion from affecting the mounting of the propeller or interfering with the bearing of the stator.

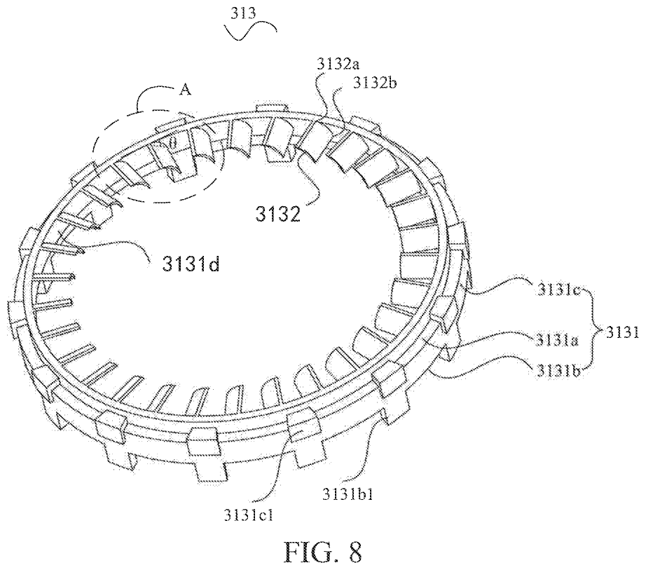

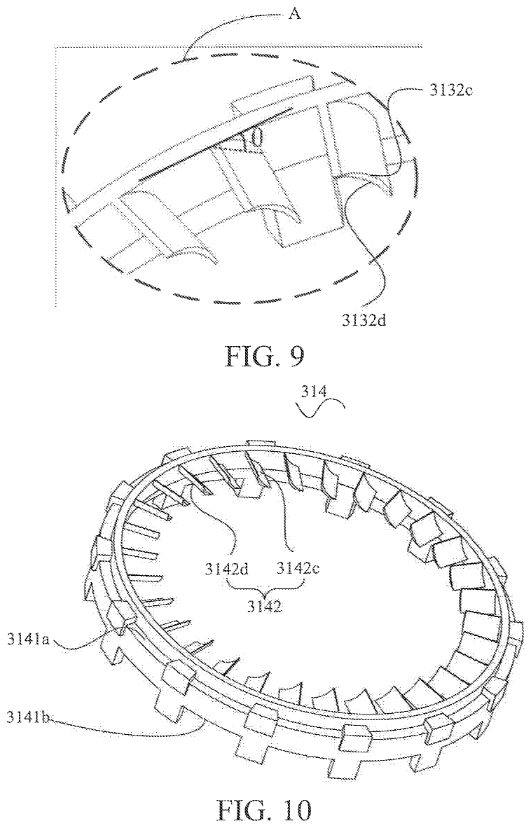

As shown in FIG. 8 to FIG. 11, the electric-motor heat dissipation member 313 includes a main body 3131 and heat dissipation fins 3132 disposed on the main body 3131. The main body 3131 has an upper end surface 3131a, a lower end surface 3131b, an outer wall surface 3131c located between the upper end surface 3131a and the lower end surface 3131b and an inner wall surface 3131d opposite to the outer wall surface 3131c. The plurality of heat dissipation fins 3132 is distributed on the inner wall surface 3131d. The heat dissipation fin 3132 has a first end portion 3132a close to the upper end surface 3131a and a second end portion 3132b close to the lower end surface 3131b. An angle θ between a line connecting the first end portion 3132a and the second end portion 3132b and a plane perpendicular to an axis of the main body (that is, the axis of the electric motor) is an acute angle (as shown in FIG. 9). Different angles θ have different guiding effects for air near the electric motor. In this embodiment, to better form a turbulent air flow inside the electric motor, the angle θ satisfies: 2°≤θ≤30°. Optionally, in some implementations, an angle between the heat dissipation fin 3132 and a plane formed by the upper end surface 3131a is an acute angle.

The working principle of the electric-motor heat dissipation member 313 is as follows: When the electric-motor heat dissipation member 313 rotates along with the rotor 312, the heat dissipation fins 3132 generate an upward or downward induction force for air around the electric motor 31, to increase the ventilation volume inside the electric motor 31 and form a turbulent air flow inside the electric motor 31, so as to actively and quickly take away the heat generated inside the electric motor 31 through the open outer cover 3123 or the open stator base 3111.

To form a better turbulent air flow channel inside the electric motor and improve the heat dissipation efficiency of the electric motor, the electric-motor heat dissipation member 313 is concentric with the stator 311. Preferably, in the embodiments of the present application, the electric-motor heat dissipation member 313 is fixedly mounted on a surface of the outer cover 3123 facing the stator and is located between the outer cover 3123 and the housing 3121. In other possible embodiments, the electric-motor heat dissipation member may be fixedly disposed on the rotary shaft. For example, as shown in FIG. 8, in the electric-motor heat dissipation member 313, a plurality of clamping blocks 3131c1 is disposed at intervals along a circumferential direction of the outer wall surface 3131c of the main body 3131. The plurality of the clamping blocks 3131c1 is engaged in the grooves 3123c of the outer cover 3123. In the electric-motor heat dissipation member 313, a plurality of bosses 3131b1 protruding in a direction away from the upper end surface 3131a is disposed along a circumferential direction of the lower end surface 3131b, a clamping portion being formed between any two neighboring bosses 3131b1. An end surface of the permanent magnet 3122 facing the outer cover 3123 is received in the clamping portion to further enhance the robustness of the electric-motor heat dissipation member 313. As the electric-motor heat dissipation member 313 is directly fixedly mounted between the outer cover 3123 and the housing 3121, no additional connecting part is required. Therefore, not only the heat dissipation efficiency of the electric motor is effectively improved, but also the space required for mounting the electric-motor heat dissipation member and the weight of the electric motor are reduced, thereby improving the flight performance of the aircraft.

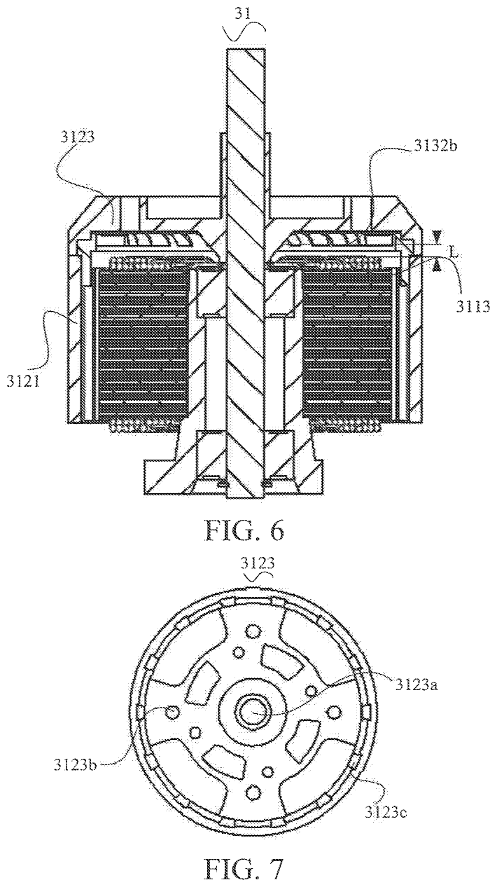

In addition, to prevent the electric-motor heat dissipation member 313 from interfering with the coil 3113 when the electric-motor heat dissipation member 313 is fixedly mounted between the outer cover 3123 and the housing 3121, as shown in FIG. 6, a distance L between the second end portion 3132b of the heat dissipation fin 3132 and the end surface of the stator 311 facing the outer cover 3123 is not less than 0.5 mm. Preferably, in this embodiment, the distance L between the second end portion 3132b of the heat dissipation fin 3132 and the end surface of the stator 311 facing the outer cover 3123 is set to 0.5 mm, to reduce the height of the housing 3121 while preventing the electric-motor heat dissipation member 313 from interfering with the coil 3113, and thus reduce the weight of the housing 3121. In this way, the weight of the electric motor 31 is basically the same as that of an electric motor not having the electric-motor heat dissipation member, so that the efficiency of the electric motor is improved.

The electric-motor heat dissipation fin 3132 may be of any shape, including but not limited to streamline-shaped, fan-shaped, arc-shaped, airfoil-shaped or S-shaped. Preferably, in this embodiment, the heat dissipation fin 3132 is arc-shaped, airfoil-shaped or S-shaped to increase the induction force of the electric-motor heat dissipation member 313 for air. Further, using a line connecting the first end portion 3132a and the second end portion 3132b along an outer surface of the heat dissipation fin 3132 as a chord, a central angle corresponding to the chord may be 12°-30°, to increase the upward or downward induction force of the heat dissipation fin 3132 for air, and increase the ventilation volume. In practical applications, heat dissipation fins of different shapes may be used depending on the rotation manner or mounting direction of the electric motor, to form a more effective turbulent air flow channel. For example, if the electric motor always rotates along one direction, the direction in which outside air flows into the electric motor is fixed during running of the electric motor. In this case, to adapt to the flow direction of air, arc-shaped or airfoil-shaped heat dissipation fins may be used.

For the electric motor 31 in the embodiments of the present application, if the electric motor rotates clockwise, outside air enters through the heat dissipation holes 3123a of the outer cover. To form a downward induction force for air so that the air is blown into the electric motor through the electric-motor heat dissipation member 313 and takes heat generated inside the electric motor (for example, heat generated by the coil, the rotary shaft, the bearing and the like) out of the electric motor through the vent hole 3111c of the stator base, as shown in FIG. 8 and FIG. 9, the heat dissipation fin 3132 has a convex arc surface 3132c curved toward the upper end surface 3131a and a concave arc surface 3132d curved toward the lower end surface 3131b. The heat dissipation fin 3132 is airfoil-shaped, to increase the speed of inducing air upward or downward and increase the ventilation volume.

As shown in FIG. 10, if the electric motor rotates anticlockwise, outside air enters through the vent hole 3111c of the stator base. To form an upward induction force for air so that the air is blown into the electric motor through the electric-motor heat dissipation member 314 and takes heat generated inside the electric motor (for example, heat generated by the coil, the rotary shaft, the bearing and the like) out of the electric motor through the heat dissipation hole 3123a of the outer cover, the electric-motor heat dissipation member 314 has a structure similar to that of the electric-motor heat dissipation member 313 provided in the embodiments of the present application, except that the heat dissipation fin 3132 of the electric-motor heat dissipation member 314 has a concave arc surface 3142c curved toward the upper end surface 3141a and a convex arc surface 3142d curved toward the lower end surface 3141b.

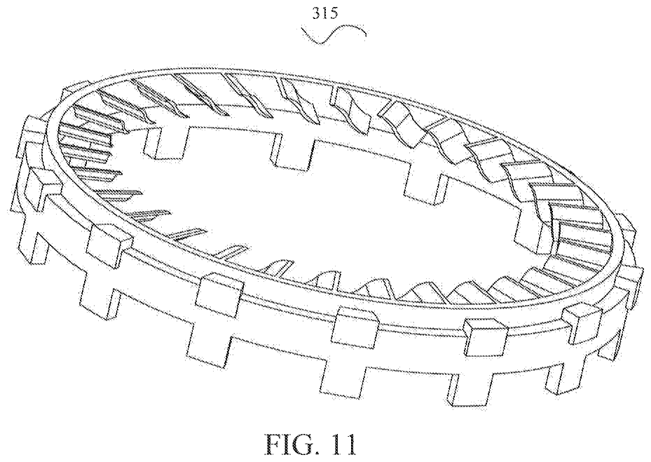

If a control switch configured to change the phase sequence is disposed inside the electric motor, the electric motor may rotate either clockwise or anticlockwise after being powered. In this case, when the electric motor runs, the direction in which outside air flows into the electric motor may be upward or downward. In this case, to achieve a good heat dissipation effect during both clockwise and anticlockwise rotation of the electric motor, an electric-motor heat dissipation member 315 with S-shaped heat dissipation fins may be used (as shown in FIG. 11).

The electric motor provided in the foregoing embodiments is an outer-rotor type electric motor, that is, the rotor of the electric motor is sleeved on the periphery of the stator and is rotatable about the stator. In another embodiment of the present application, an inner-rotor type electric motor is further provided, the electric motor including an electric-motor heat dissipation member connected to the rotor. The inner-rotor type electric motor provided in the embodiments of the present application has a structure similar to that of the outer-rotor type electric motor provided in the foregoing embodiments. The difference between the two electric motors lies in that in the inner-rotor type electric motor, the stator of the electric motor is sleeved on the periphery of the rotor, with other structures being substantially the same as those of the outer-rotor type electric motor. The outer-rotor type electric motor has the advantages of compact structure and small volume. When a high power is required, the outer-rotor type electric motor may fail to meet the requirements on rigidity, and in this case, the inner-rotor type electric motor is adapted. Which type of electric motor is to be used is determined based on actual situations.

It should be understood that the electric-motor heat dissipation member of the embodiments of the present application are applicable to both the outer-rotor type electric motor and the inner-rotor type electric motor, and can achieve the same beneficial effects. Details are not described herein.

In addition, in practical applications, the shape of the heat dissipation fin 3132 may be selected depending on the mounting direction of the electric motor 31 on the aircraft 100, to improve the heat dissipation effect of the aircraft 100. For example, if the power plant 3 is mounted toward above the aircraft body 1 (direction a shown in FIG. 1), the heat dissipation fin of the electric motor is arc-shaped or airfoil-shaped, and has a convex arc surface curved toward the upper end surface of the main body of the electric-motor heat dissipation member and a concave arc surface curved toward the lower end surface of the main body of the heat dissipation fin; if the power plant 3 is mounted toward below the aircraft body 1 (direction b shown in FIG. 1), the heat dissipation fin of the electric motor is arc-shaped or airfoil-shaped, and has a concave arc surface curved toward the upper end surface of the main body of the electric-motor heat dissipation member and a convex arc surface curved toward the lower end surface of the main body of the heat dissipation fin. Alternatively, to adapt to different application scenarios, the electric-motor heat dissipation member 315 with S-shaped heat dissipation fins may be selected.

The material of the electric-motor heat dissipation member 313 may be plastic or steel sheets. Preferably, in this embodiment, the material of the electric-motor heat dissipation member 313 is plastic, to reduce the weight of the electric motor and improve the efficiency of the aircraft.

To sum up, different from the prior art, the electric-motor heat dissipation member provided in the embodiments of the present application can form a turbulent air flow inside the electric motor when the rotor drives the heat dissipation member to rotate, and the turbulent air flow can actively take away heat generated inside the electric motor, to improve the efficiency of the air flow in taking the heat inside the electric motor out of the electric motor, thereby improving the heat dissipation effect of the electric motor. Further, the application of the electric motor using the electric-motor heat dissipation member to an aircraft can improve the flying efficiency and the safety performance of the aircraft.

It should be noted that, the specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the above technical features can further be combined to form various embodiments not listed above, and all such embodiments shall be construed as falling within the scope of this application. Further, persons of ordinary skill in the art may make improvements and variations according to the above descriptions, and such improvements and variations shall all fall within the protection scope of the appended claims of this application.

What is claimed is:

1. An electric-motor heat dissipation member, comprising a main body and heat dissipation fins disposed on the main body, the main body having an upper end surface, a lower end surface, an outer wall surface located between the upper end surface and the lower end surface, and an inner wall surface opposite to the outer wall surface,
wherein the heat dissipation fins are disposed on the inner wall surface, and the heat dissipation fin has a first end portion close to the upper end surface and a second end portion close to the lower end surface.

2. The electric-motor heat dissipation member according to claim 1, wherein an angle between the heat dissipation fin and a plane formed by the upper end surface is an acute angle.

3. The electric-motor heat dissipation member according to claim 1, wherein an angle θ between a line connecting the first end portion and the second end portion and a plane perpendicular to an axis of the main body is an acute angle.

4. The electric-motor heat dissipation member according to claim 3, wherein the angle θ satisfies: 2°≤θ≤30°.

5. The electric-motor heat dissipation member according to claim 1, wherein a plurality of clamping blocks is disposed at intervals along a circumferential direction of the outer wall surface of the main body.

6. The electric-motor heat dissipation member according to claim 1, wherein a plurality of bosses protruding in a direction away from the upper end surface is disposed along a circumferential direction of the lower end surface, a clamping portion being formed between any two neighboring bosses.

7. The electric-motor heat dissipation member according to claim 1, wherein the heat dissipation fin is arc-shaped, airfoil-shaped or S-shaped.

8. The electric-motor heat dissipation member according to claim 1, wherein using a line connecting the first end portion and the second end portion along an outer surface of the heat dissipation fin as a chord, a central angle corresponding to the chord is 12°-30°.

9. An electric motor, comprising a stator and a rotor sleeved on a periphery of the stator and rotatable about the stator, the electric motor further comprising an electric-motor heat dissipation member connected to the rotor,
the electric-motor heat dissipation member comprising a main body and heat dissipation fins disposed on the main body, the main body having an upper end surface, a lower end surface, an outer wall surface located between the upper end surface and the lower end surface, and an inner wall surface opposite to the outer wall surface, wherein the heat dissipation fins are disposed on the inner wall surface, and the heat dissipation fin has a first end portion close to the upper end surface and a second end portion close to the lower end surface.

10. The electric motor according to claim 9, wherein an angle between the heat dissipation fin and a plane formed by the upper end surface is an acute angle.

11. The electric motor according to claim 9, wherein an angle θ between a line connecting the first end portion and the second end portion and a plane perpendicular to an axis of the main body is an acute angle.

12. The electric motor according to claim 11, wherein the angle θ satisfies: 2°≤θ≤30°.

13. The electric motor according to claim 9, wherein a plurality of clamping blocks is disposed at intervals along a circumferential direction of the outer wall surface of the main body; and
the rotor comprises a housing sleeved on the periphery of the stator and rotatable about the stator, an outer cover connected to an end of the housing and a permanent magnet disposed on a surface of the housing facing the stator, the outer cover being provided with grooves at positions corresponding to the clamping blocks, the clamping blocks being engaged in the grooves.

14. The electric motor according to claim 13, wherein a plurality of bosses protruding in a direction away from the upper end surface is disposed along a circumferential direction of the lower end surface, a clamping portion being formed between any two neighboring bosses; and an end surface of the permanent magnet facing the outer cover being received in the clamping portion.

15. The electric motor according to claim 9, wherein a distance between the second end portion of the heat dissipation fin and an end surface of the stator facing the outer cover is not less than 0.5 mm.

16. The electric motor according to claim 9, wherein the heat dissipation fin is arc-shaped, airfoil-shaped or S-shaped.

17. The electric motor according to claim 9, wherein using a line connecting the first end portion and the second end portion along an outer surface of the heat dissipation fin as a chord, a central angle corresponding to the chord is 12°-30°.

18. An aircraft, comprising an aircraft body, an arm extending from the aircraft body and a power plant disposed on the arm, the power plant comprising an electric motor of any of claims 9 to 17 connected to the arm and a propeller connected to the electric motor, the electric motor being configured to provide power for rotation of the propeller.

19. The aircraft according to claim 18, wherein the power plant is mounted toward above the aircraft body, and the heat dissipation fin of the electric motor is arc-shaped or airfoil-shaped and has a convex arc surface curved toward the upper end surface of the main body of the electric-motor heat dissipation member and a concave arc surface curved toward the lower end surface of the main body of the electric-motor heat dissipation member.

20. The aircraft according to claim 18, wherein the power plant is mounted toward below the aircraft body, and the heat dissipation fin of the electric motor is arc-shaped or airfoil-shaped and has a concave arc surface curved toward the upper end surface of the main body of the electric-motor heat dissipation member and a convex are surface curved toward the lower end surface of the main body of the electric-motor heat dissipation member.
